(19) United States
(12) Patent Application Publication
(10) Pub. No.: US 2005/0017462 A1
(43) Pub. Date: Jan. 27, 2005

(54) Suspension system

(76) Inventor: William J. Kroppe, Ann Arbor, MI (US)

Correspondence Address: Liniak, Berenato & White, 6550 Rock Spring Drive, Ste. 240, Bethesda, MD, 20817, US

(21) Appl. No.: 10/624,538

(22) Filed: Jul. 23, 2003

(51) Int. Cl. B60G 17/005

(52) U.S. Cl. 280/5.507

(57) ABSTRACT

A suspension control system designed to impart a variable supplemental resistive force to control vehicle body roll and to improve suspension performance through the use of magnetic rheologic force devices. Each of the force devices impart rheologically adjustable amounts of force and resistance to the vehicle suspension system based on a variable magnetic/electrical field created within the force devices. The control system further includes a plurality of sensors that monitor vehicle components and performance parameters, and send signals to a logic unit. The logic unit processes input from the sensors and sends electrical commands to the force devices, which take the appropriate action to optimize suspension system performance. The use of the magnetic rheological force devices supplants traditional stabilizer bars and the associated linkages, fasteners, brackets and insulators.

### BACKGROUND OF THE INVENTION

1. Field of the Invention

The invention generally relates to suspension systems. Specifically, the invention relates to suspension systems for motor vehicles, such as automobiles, busses and trucks.

2. Description of the Related Art

A typical motor vehicle suspension system comprises a passive system of shocks, springs, and stabilizer components arranged to dampen road surface vibrations and road surface anomalies commonly encountered by motor vehicles. Although passive suspension systems are somewhat effective on straight relatively smooth roads, they are not as effective in countering the dynamic rolling forces experienced by rapidly turning vehicles. Traditional suspension systems also suffer from a lack of interactive “feel” for the road and the adaptive flexibility particularly required by sports cars or off road vehicles.

The prior art also includes complex active suspension systems designed to actively detect and counter virtually every road surface-related variation. These systems employ multiple deadening devices and an extensive network of sensors, and processors to anticipate and respond to road surface conditions. While these systems deliver near-optimal suspension results, they are also extremely expensive to produce, install, and maintain, and they are vulnerable to hardware and software failures as a result of their complex and extensive hardware and software designs.

In order to increase reliability, decrease costs, and improve performance, the present invention has been developed. The invention may be used in any motor vehicle, but is designed primarily for trucks, busses and automobiles. In operation, the invention reduces undesirable body roll and improves overall suspension performance.

### SUMMARY OF THE INVENTION

The invention comprises a suspension control system that imparts a variable supplemental resistive force to control vehicle body roll and improve suspension performance through the use of magnetic rheological force devices. The force devices may be mounted separately in a modular-type configuration, or they may be installed as an integral part of a conventional suspension assembly system. Additionally, vehicles originally produced without the force devices may be retrofitted to include the devices. Each of the force devices impart electronically adjustable amounts of force and resistance to the vehicle suspension system based on a variable magnetic/electrical field created within the force devices. The control system further includes a plurality of sensors that monitor vehicle components and performance parameters, and send signals to a logic unit. The logic unit processes input from the sensors and sends electrical commands to the force devices, which take the appropriate action to optimize suspension system performance.

### BRIEF DESCRIPTION OF THE DRAWING

FIG. 1 is a depiction of the roll axis of a vehicle.

FIG. 2a is a schematic illustrating the preferred embodiment of the invention.

FIGS. 2b, 2c, and 2d are alternate embodiments wherein the magnetic rheologic force device is interconnected with the coil spring or shock absorber in different configurations.

FIG. 3 is a schematic of the magnetic rheologic force device.

FIG. 4 is a flow chart describing the roll control system.

FIG. 5 is a graph comparing the roll characteristics of a vehicle with the present invention installed, to a vehicle without the system installed.

### DETAILED DESCRIPTION OF THE PREFERRED EMBODIMENT

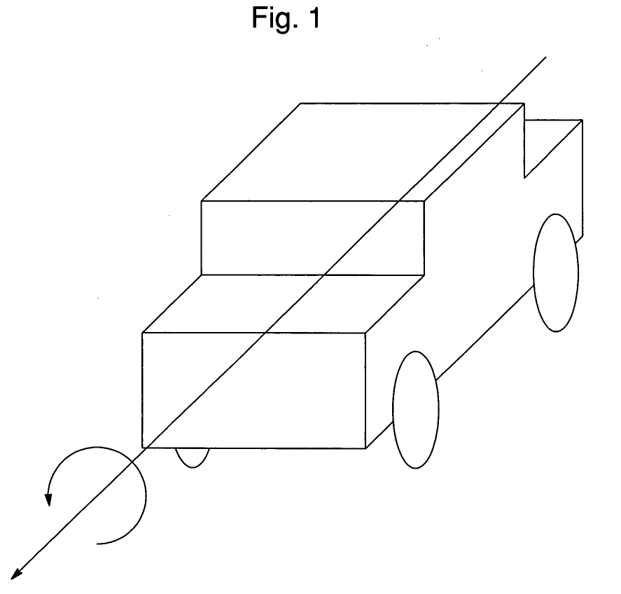

The present invention is an active drop link roll control system that imparts a variable supplemental resistive force to control the roll characteristics of a motor vehicle. FIG. 1 illustrates the roll axis of a typical automobile. To control movement about the roll axis, the present invention employs a suspension system enhanced by magnetic rheologic force devices and controlled by a logic unit.

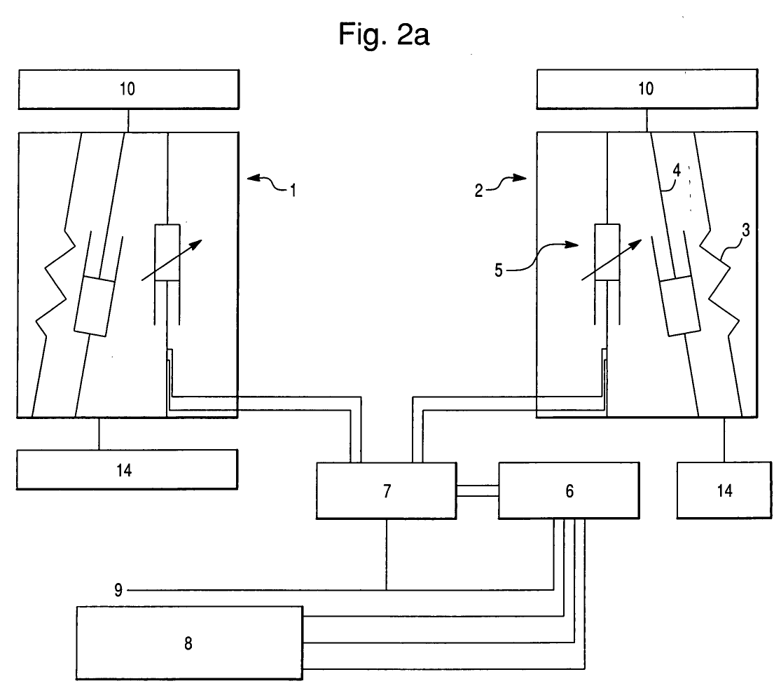

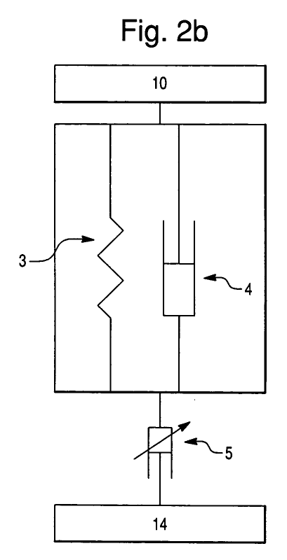

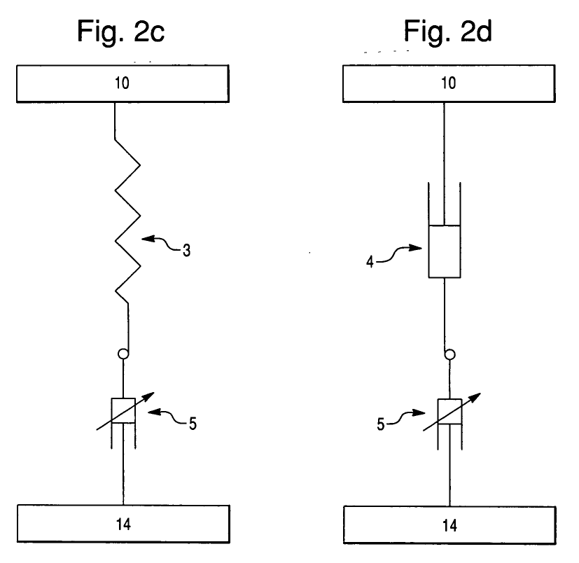

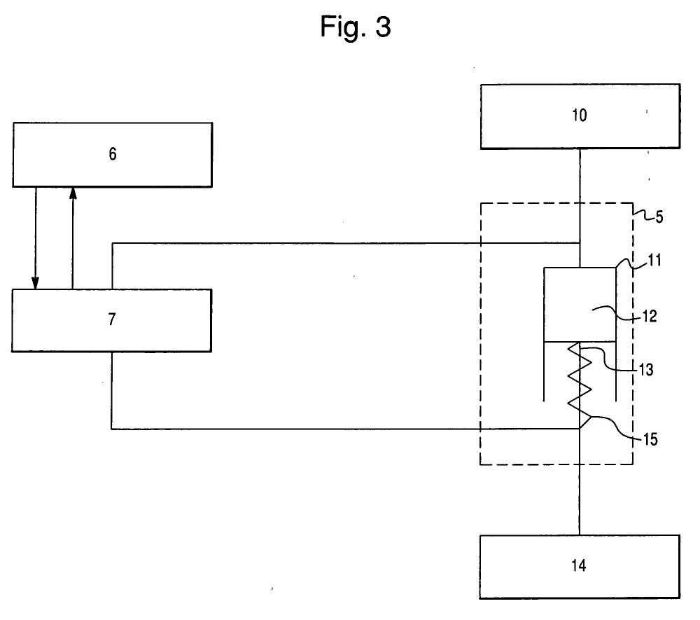

FIGS. 2a-2d and 3 are schematics illustrating the active drop link roll control system of the present invention. As best shown in FIG. 2a, the system is comprised of at least two suspension assemblies (1, 2) corresponding to individual wheels, or more generally, to the sides of a vehicle. The suspension assembly comprises shock absorbers (3) and coil springs (4) to provide a vehicle with conventional passive suspension support. The suspension further includes an energy absorbing magnetic rheologic force device (5) positioned between the wheel support members (14) and the vehicle body (10). FIGS. 2b-2d illustrate alternate configurations of the magnetic force devices (5) and the primary suspension system members.

As best illustrated in FIG. 3, the magnetic rheologic force device (5) includes a movable piston (13) disposed within a corresponding housing (11). The housing (11) encloses a chamber (12) filled with a magnetorheological (or electrorheological) fluid. The viscosity of the magnetorheological fluid limits the movement of the piston (13) within the housing. The piston may have a variable or constant sized aperture(s) that also constricts the movement of fluid. The viscosity of the magnetorheological fluid can be adjusted by varying an electrical/magnetic field created within the magnetorheological fluid. Adjusting the electrical field instantly adjusts the viscosity of the magnetorheological fluid, which instantly modifies the magnetic rheologic force device (5), which, in turn, instantly impacts the vehicle's suspension characteristics. The magnetic field is induced in the magnetic rheological fluid in the chamber (12) through a coil (15) that is integral with the rod portion of the piston (13). The use of the magnetic rheological force devices supplants the traditional stabilizer bars and the associated linkages, fasteners, brackets and insulators.

As best illustrated in FIG. 2a, the magnetic rheologic force devices (5) are controlled by a logic unit or processor (6) through an electronic interface system (7). The logic unit (6) monitors various vehicle components and performance parameters through a network of sensors (8). Parameters and components monitored include, but are not limited to, steering wheel angle, lateral acceleration, vehicle speed, suspension position, etc. The monitoring of multiple vehicle components and operating parameters are common and well known in the art. The logic unit (6) processes the sensed information, and generates corresponding electrical commands. The commands are communicated to the electrical interface system (7), which sends electrical signals to the magnetic rheologic force devices (5). The logic unit (6) and force units (5) operate on a 12 volt power supply (9).

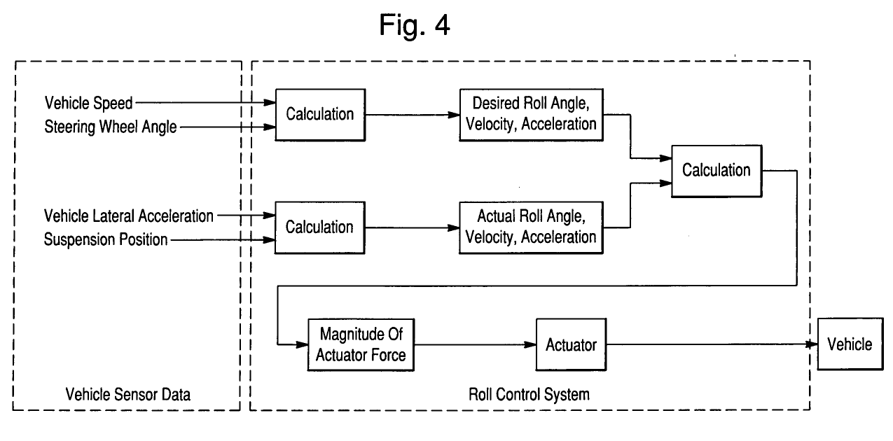

FIG. 4 is a flow chart further describing the function of the roil control system. Sensor signals are channeled to the logic unit (6) for processing. The logic unit (6) employs an algorithm to determine the optimal suspension configuration for the sensed parameters. The optimal suspension characteristics are instantly compared to the actual characteristics, and electronic instructions regarding when and how much force to apply to the suspension system are channeled to the force devices (5). The force devices alter the suspension characteristics and instantly supply electronic signals back to the logic unit (6) to further refine the suspension characteristics. The logic unit (6) algorithm determines when, how fast, and to what degree each magnetic rheologic force device (5) should be actuated. Once the magnetic rheologic force devices (5) receive a response from the logic unit (6), the force devices (5) stiffen or soften the suspension to optimize the suspension response.

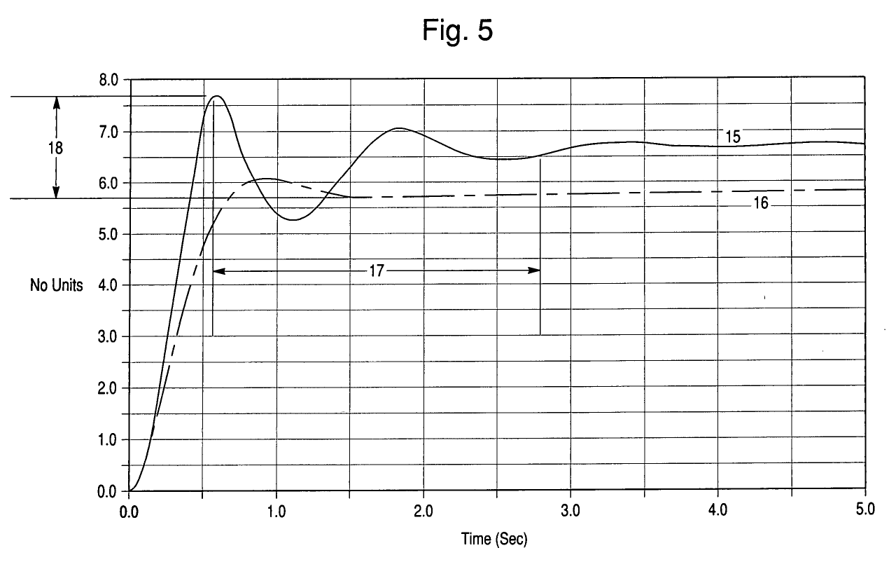

FIG. 5 is a comparison between vehicles with, and without the invention installed. The solid line (15) indicates the roll performance of a vehicle with a conventional suspension system. The dashed line (16) indicates the performance of a vehicle with the present invention installed. The vertical arrows (18) indicate unwanted vehicle overshoot, and show unwanted system oscillations. As is apparent from FIG. 5, the roll control system of the present invention quickly diagnoses excess body roll and refines suspension characteristics to optimize the suspension and reduce unwanted overshoot and body roll.

The rheologic devices (5) are independently controlled, and at least one magnetic rheologic device (5) is positioned on each of two opposing sides of a vehicle. However, a vehicle may have one or multiple force devices associated with each wheel or each designated vehicle component. The magnetic rheologic force devices (5) may be modular and function completely independent of the conventional passive suspension system, or they may be integrated into the conventional system and act through the passive suspension components to control vehicle roll and optimize suspension system response. Additionally, a vehicle originally built without the force device system installed may be retrofitted to include the system. All systems operate on a 12 volt power supply (9).

In operation, during a sharp turn, for example, a conventional prior art suspension system would allow one side of the car to pitch upward, significantly changing the center of gravity and contributing to the possibility of a vehicle rollover. However, if the system disclosed in the invention was installed in the vehicle, a sensor (8) would instantly diagnose the lateral acceleration and communicate the information to the logic unit (6). The logic unit (6) would process the information and communicate the appropriate adjustment to the magnetic rheologic devices (5), which would respond to counter the affects of the sharp turn and effectively prevent the rollover condition from developing.

For the foregoing reasons, it is clear that the invention provides an improved vehicle suspension system. The invention may be modified in multiple ways and applied in various technological applications. The magnetic rheological system may be modified and customized as required by a specific operation or application, and the individual components may be modified and defined, as required, to achieve the effect and result. Similarly, although the materials of construction are not described, they may include a variety of compositions consistent with the function of the invention. Such variations are not to be regarded as a departure from the spirit and scope of the invention, and all such modifications as would be obvious to one skilled in the art are intended to be included within the scope of the following claims.

1. A suspension system supporting a vehicle body, said system comprising:
a wheel;
an energy absorbing assembly including a spring and damper connected between said wheel to said vehicle body;
a rheological force device connected between said wheel and said vehicle body and acting independently of said energy absorbing assembly, said rheological force device providing a variable supplemental resistive force between each of said wheels and said vehicle body;
at least one sensor to sense at least one vehicle operating parameter;
a controller in communication with said rheological force device and controlling said device in response to said at least one vehicle operating paramenter to thereby control said variable supplemental resistive force.

2. The system described in claim 1, wherein said rheologic force devices comprise a movable piston disposed within a housing containing one of magnetorheological and electrorheological fluid,
said piston movement being dependent on said fluid viscosity.

3. The system described in claim 2, wherein said fluid viscosity is dependent upon a electrical/magnetic field applied to said fluid.

4. The system described in claim 3 wherein said electrical/magnetic field is applied to said fluid by a coil integrally connected to said piston.

5. The system as described in claim 4 wherein the relative movement between said vehicle body and said at least two wheels is at least partially dependent on said electrical/magnetic field applied to said fluid.

6. The system described in claim 1, wherein said sensors include at least one of steering wheel angle, lateral acceleration, or vehicle speed.

7. The system described in claim 1, wherein said sensors include at least steering wheel angle, lateral acceleration, and vehicle speed.

8. The system described in claim 1, wherein said controller processes said signal by applying a predetermined algorithm.

9. The system described in claim 1, wherein said suspension system includes at least two said rheological force devices disposed on opposite sides of said vehicle,
said rheological devices being independently controlled by said controller.

10. The system as described in claim 1, wherein said suspension system includes at least four rheological force devices,
said rheological devices being independently controlled by said controller.

11. The system as described in claim 1, wherein said controller and said force devices operate on a 12 volt system,
said controller communicating with said force devices by sending information to an electrical interface system,
said electrical interface system sending an electrical signal to said electrical force device.

12. A controllable suspension system, said system comprising:
at least two wheels,
at least two wheel supporting members for rotatably supporting each of said at least two wheels,
a vehicle body,
a suspension system connecting said wheel supporting members to said body,
said suspension system comprising shock absorbers, coil springs, and at least two force devices,
at least one sensor that senses a vehicle performance parameter and communicates said parameters as a signal,
a controller that processes said signal and communicates electronic information to said at least two force devices,
said at least two force devices directly modifying said suspension system response.

13. The system described in claim 12, wherein each of said at least two wheel supporting members includes an axle.

14. The system described in claim 12, wherein said magnetic rheologic force devices comprise a movable piston disposed within a housing filled with one of magnetorheological and electrorheological fluid,
said piston movement being dependent on said fluid viscosity.

15. The system described in claim 14, wherein said fluid viscosity is dependent upon an electrical/magnetic field applied to said fluid.

16. The system described in claim 15, wherein said electrical/magnetic field is applied to said fluid by a coil integrally connected to said piston.

17. The system as described in claim 14, wherein the relative movement between said vehicle body and said at least two wheel support members is at least partially dependent on said electrical/magnetic field applied to said fluid.

18. The system described in claim 12, wherein said sensors include at least one of steering wheel angle, lateral acceleration, or vehicle speed.

19. The system described in claim 12, wherein said sensors include at least steering wheel angle, lateral acceleration, and vehicle speed.

20. The system described in claim 19, wherein said controller processes said signal by applying a predetermined algorithm.

21. The system as described in claim 21, wherein said controller and said force devices operate on a 12 volt system.

22. The system as described in claim 21, wherein said rheologic force device is connected in parallel with said shock absorber and said coil spring.

23. The system as described in claim 21, wherein said rheologic force device is connected in parallel with one of said shock absorber and said coil spring.

24. The system as described in claim 21, wherein said rheologic force device is connected in series with a combination of said coil spring and said shock absorber.

25. The system as described in claim 21, wherein said rheologic force device is connected in series with one of said coil spring and said shock absorber.

26. The system as described in claim 22, wherein said suspension system includes at least four rheological force devices,
said rheological devices being independently controlled by said controller.

27. A vehicle body roll reducing system, said system comprising:
at least two wheels,
at least two wheel supporting members for rotatably supporting each of said at least two wheels,
a vehicle body,
a suspension system connecting said wheel supporting members to said body,
said suspension system comprising coil springs, shock absorbers, and at least two magnetic rheologic force devices,
said at least two magnetic rheologic force devices being disposed on opposite sides of said vehicle,
said magnetic rheologic force devices comprising a movable piston disposed within a housing filled with one of magnetorheological or electrorheological fluid,
said piston movement being dependent on said fluid viscosity,
said fluid viscosity being dependent on the electrical field applied to said fluid,
movement between said wheel support member and said vehicle body being at least partially dependent on said electrical field applied to said fluid,
said magnetic rheological force devices functioning independently of said coil springs and said shocks,
said magnetic rheologic force devices having no direct connection to said shock and said coil spring,
at least one sensor that senses a vehicle performance parameter and communicates said parameters as a signal,
said at least one sensor sensing at least one of steering wheel angle, lateral acceleration, and vehicle speed,
a controller that processes said signal and communicates electronic information to said at least two magnetic rheological force devices through and electrical interface system,
said at least two magnetic rheological force devices directly modifying said suspension system response,
said controller processing said signal by means of a predetermined algorithm,
said controller and said two magnetic rheologic force devices operating on a twelve volt system.

28. A vehicle body roll reducing system for a suspension of a vehicle having at least one pair of axles each provided with at least one pair of wheels mounted thereon, said vehicle body roll reducing system comprising:
a first wheel supporting member for rotatably supporting a first wheel of said at least one pair of wheels mounted on one of said at least one pair of axles;
a second wheel supporting member for rotatably supporting a second wheel of said at least one pair of wheels mounted on one of said at least one pair of axles;
a first spring and shock absorber assembly connecting said first wheel supporting member to a vehicle body;
a second spring and shock absorber assembly connecting said second wheel supporting member to said vehicle body;
first and second force devices functioning independently from said first and second spring and shock absorber assemblies, said first force device connecting said first wheel supporting member to said vehicle body, said second force device connecting said second wheel supporting member to said vehicle body, each of said first and second force devices is filled with one of a magnetorheological and electrorheological fluid and provides a resistance to the displacement of said wheel supporting members relative to said vehicle body due to a viscosity of said fluid;
at least one sensor for sensing a vehicle condition and producing a sensor signal indicative of said vehicle condition; and
a controller responsive to said sensor signal of said at least one sensor for deriving a control signal to operate said first and second force devices by varying said viscosity of said fluid.

29. The vehicle body roll reducing system as defined in claim 24, wherein each of said first and second force devices includes:
a housing filled with one of said magnetorheological and electrorheological fluid; and
a piston member provided for displacement within said housing so that an amount of displacement of said piston relative to said housing being limited by resistance provided by a viscosity of said fluid.
